(19) United States
(12) Patent Application Publication
(10) Pub. No.: US 2008/0202343 A1
(43) Pub. Date: Aug. 28, 2008

(54) Moisture Absorption Apparatus

(76) Inventor: John Ivar Allan Lundin, Banyuwangi (ID)

Correspondence Address: GREER, BURNS & CRAIN, 300 S WACKER DR, 25TH FLOOR, CHICAGO, IL, 60606, US

(21) Appl. No.: 11/910,396

(22) PCT Filed: Apr. 3, 2006
(86) PCT No.: PCT/ID06/00003

§ 371 Date: Oct. 1, 2007

(30) Foreign Application Priority Data
Apr. 1, 2005 (ID) S00200500034

(51) Int. Cl. B01D 53/26; B01J 20/02

(52) U.S. Cl. 96/118; 95/231; 252/194

(57) ABSTRACT

An improved air humidity absorbing device to be used in a cargo container, includes: an external box made from cardboard material; the contents of the box including an external bag made from non woven spunbound; and at least two internal bags from the coated Tyvek material. The at least two internal bags are formed by subdividing the external bag into the at least two internal bags, and each of the internal bags is filled with an active mixture including Calcium Chloride (CaCl2) and Amylopectin.

### FIELD OF THE INVENTION

The invention relates to an air humidity absorber device to be used in cargo containers. More particularly, a vapor absorbing device for use in a humid air condition caused by the air condensation in the transportation room of a cargo container or the like.

### BACKGROUND OF THE INVENTION

The transportation of goods, especially by boat using a container to transport certain products, is subject to the problems caused by condensation and the perspiration of the container interior. The problems become dominant when using a container to transport the cargo. These problems can lead to great loss in world commerce, especially international trade, if not noticed in advance, due to the damage and degradation of the contained goods and adverse affect on quality caused by this condensation. The problems are commonplace and must be immediately anticipated, especially with containers sent to or coming from areas of different climate, such as from an area having a tropical climate to an area having a cooler climate.

According to the elementary theory of physics, the relative humidity of air shows the ratio of the amount of aqueous vapor existing in the air to the amount of aqueous vapor (saturated aqueous vapor) capable of being arrested by the air at a certain temperature. It can also be defined as a term which can indicate the amount of maximum aqueous vapor in the air relative to the amount of maximum aqueous vapor which can be arrested by pertinent air at a certain temperature. Relative humidity (RH) expressed in percent (%) is calculated by dividing the amount of aqueous vapor in the air with the amount of aqueous vapor capable of being arrested by the air at the same temperature, then multiplied by 100. For example, RH 50% means the air only contains 50% aqueous vapor from the total (maximum) of vapor capable of being arrested by the air at a certain temperature. Thereby, it can be said that if an air relative humidity (RH) 100% occurs, which can be reached at a certain temperature, it means that the saturated dew point has been reached, resulting in condensation. Dew Point is the temperature in which partial vapor pressure becomes saturated.

In general, the amount of water contained in a material depends on material type and relative humidity of ambient air at the time of inflow of goods into the container. Proven that equatorial temperature contains higher humidity compared to the air in cooler weather, the goods entered into the container contain the water therein and aqueous vapor in the air potentially causing condensation.

Condensation that occurs in the product is generally the worst case scenario and the damage to due this humidity problem can be readily observed. In most cases, material packaging made to keep the humidity level below the threshold which is allowed, usually below condensation level, occurs at the moment of stability and the balance of the product and other components are often affected.

At a hot temperature, the air can arrest aqueous vapor higher than at a cool air condition. If the amount of aqueous vapor existing in air is constant, while its temperature increases, its relative humidity will decrease. On the contrary, if air temperature is decreased, relative humidity (RH) will increase.

When cargo transported in containers (meaning that the amount of aqueous vapor in the air is constant), is brought from an area having a high temperature (for example, a tropical area, like Indonesia and its surroundings) to an area having a lower temperature (for example, a continent area in the northern or southern hemispheres, having four seasons), condensation problems in the container will occur. By the occurrence of this temperature change, the air in the container is unable to arrest aqueous vapor therein so that there remains to be aqueous vapor. Because the dew point (or RH 100%) has been reached, the aqueous vapor turns into the drops of water which are evident on the walls of the container when opened at the receiving location; these water droplets are condensation.

The increase in relative humidity (RH) inside the container will accelerate corrosion (especially for the metallic parts of the container), fungi proliferation and other microorganism growth (for production materials, the result of agriculture, and the like), and also other effects which in general will degrade the quality of the cargo loaded into the container. Finally, by increasing the humidity, the resulting condensation is also very harming because a drip of water will seriously damage cargo especially comprising electronic products, furniture, machines, and the like.

The above problems will become more complex, if cargo which is transported in containers includes goods having a high water content, like agricultural products, for example wood/furniture, coffee, tea, mace, and the like.

Based on the aforementioned, it can be concluded that efforts to maintain the quality of goods due to a natural process, may be achieved by setting the relative humidity (RH) of the air of the transportation room of a cargo container, resulting from a temperature change and the presence of hygroscopic equilibration processes that occurred.

### SUMMARY OF THE INVENTION

The object of the invention is to create an improved air humidity absorbing device to be used in a cargo container.

Another object of the invention is to provide an air humidity absorbing device to be used in a cargo container which can absorb the aqueous vapor resulting from humid air conditions generated by air condensation in the transportation room of the cargo container or the like.

Another object of the invention, other than to provide the improved air humidity absorbing device, is to provide packaging for the device. This packaging consists of an external box which is in the form of a trapezium and made from cardboard, an internal box consisting of an external bag and an internal bag, in which the external bag is made from non woven spunbound cloth and the internal bag is made from Tyvek Quted material. The internal bag consists of two Tyvek Quted bags each of which is filled with the active mixture of Calcium Chloride (CaCl2) and Amylopectin. The external box having small holes with diameters equal to 0.9 cm, the frontage of the box having five hole groups each of which consists of twenty five holes, and both sides of the box having four hole groups each of which consists of five holes. The backside of the box is tightly closed (without holes), from which the box will be attached to the container wall by its hanger.

The external bag preferably comprises of more than one bag, each bag preferably divided into five parts of bag, where each of which is filled with two Tyvek Quted bags, each Tyvek Quted bag being filled with the active mixture of Calcium Chloride (CaCl2) and Amylopectin, as much 100 gr.

The active mixture of Calcium Chloride (CaCl2) in pellet or granular form, the diameter range being 2-5 mm, where the composition of each granule consists of:

| | |
|---|---|
| Calcium Chloride (CaCl2) | 74% |
| Sodium Chloride (Nacl) | 2.8% |
| Calcium Hydroxide Ca(OH)2 | 0.33% |
| Water Insoluble | 0.18% |
| Magnesium Chloride (MgCl2) | 0.07% |
| pH = 8 | |

Polymer Amylopectin as a mixture consists of:

| | |
|---|---|
| Protein | 0.09% |
| Fat | 0.13% |
| Moisture | 12.49% |
| Ash | 0.16% |
| Starch | 84.11% |
| Raw Fiber | 0.37% |
| pH = 6.43 (10% in water) | |
| Electric Conductivity = 187 μS. | |

### BRIEF DESCRIPTION OF THE FIGURES

FIG. 1 represents a view from the front of the improved air humidity absorbing device according to this invention;

FIG. 2 represents a view from the side of the improved air humidity absorbing device according to FIG. 1;

FIG. 3 represents a view from the back of the improved air humidity absorbing device according to FIGS. 1 and 2;

FIG. 4 represents a view from the top of the improved air humidity absorbing device according to FIGS. 1-3;

FIG. 5 represents the external box made from stiff cardboard, provided with the humid air passage holes for the improved air humidity absorbing device according to this invention;

FIG. 6a represents the bag of Tyvek Quted; and

FIG. 6b represents the bag of non woven spunbound cloth consisting of the arrangement of five bags of Tyvek Quted.

### DETAILED DESCRIPTION OF THE INVENTION

By reference to the drawings of the invention, the improved air humidity absorbing device (1) consists of the external box (2) and the external bag (3) of non woven spunbound cloth which lies inside the external box (2). The external bag (3), preferably made from more than one bag, each bag preferably divided into five bag parts, where the successive parts of the internal bags (4) are filled with two Tyvek Quted bags.

Each of the Tyvek Quted bags are filled with the active mixture of Calcium Chloride (CaCl2) and Amylopectin as much as 100 gr. Calcium Chloride (CaCl2) being used consists of ±50%, but also can be used with the active mixture ranges between 74-94.4%, whereas minimal level is 74%.

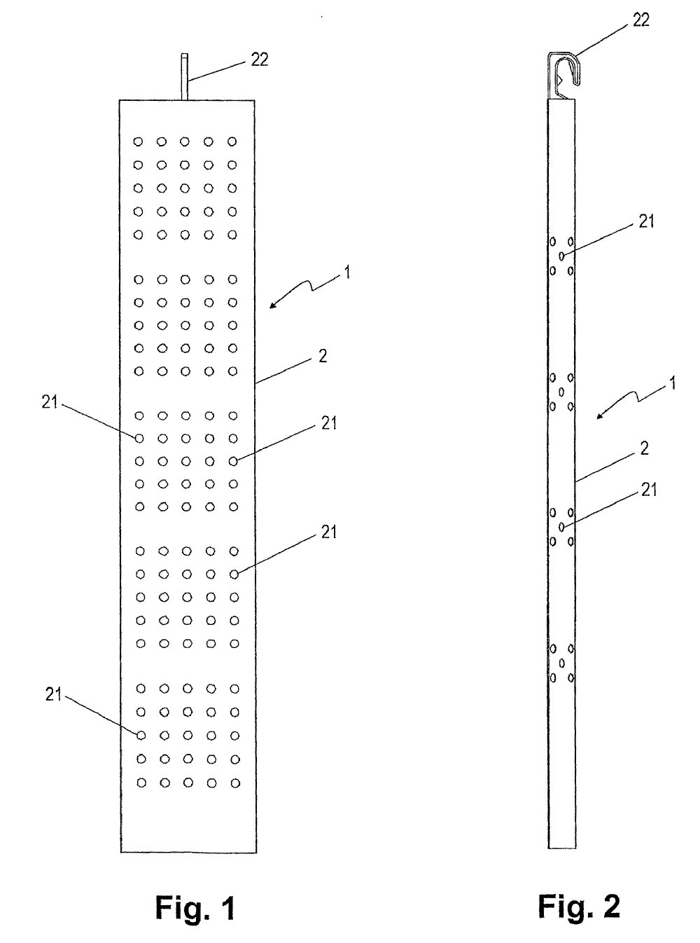

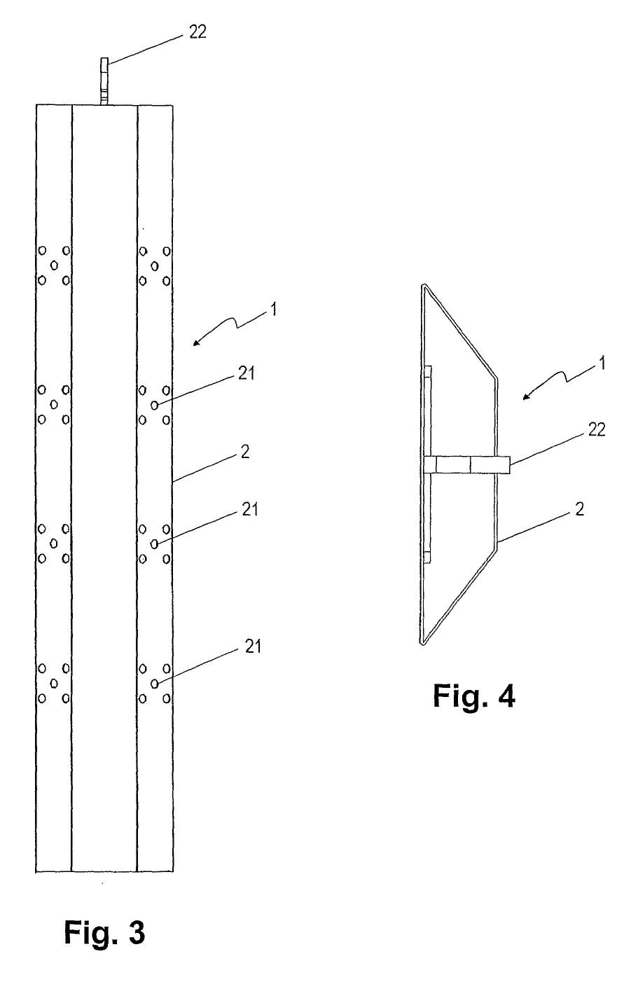

The external box (2) is made from stiff cardboard with thickness ±1 mm and designed to be provided with small holes (21) with hole diameter size 0.9 cm, the front of the external box (2) having five hole groups each of which consists of twenty five holes (see FIG. 1), and both sides of the box having four hole groups, each of which consists of five holes (see FIGS. 2 and 3). The backside of the box is tightly closed (without holes), from which the box will hang from the container wall (see FIG. 3). The external box (2) is rectangular in shape with one of the sides, the shortest, being given the hanger (22), so that the box (2) can be hung in a perpendicular position (see FIGS. 1-3). This box (2) , if seen from its cross-section, is trapezoidal in shape (see FIG. 4) where the longest side of the parallel side surfaces is designed to face forwards to place the small holes (21), while the other surface of parallel sides not having small holes (21) because this surface attaches to the wall; both surfaces of its inclined side also having small holes (21) for the inlet of humid air.

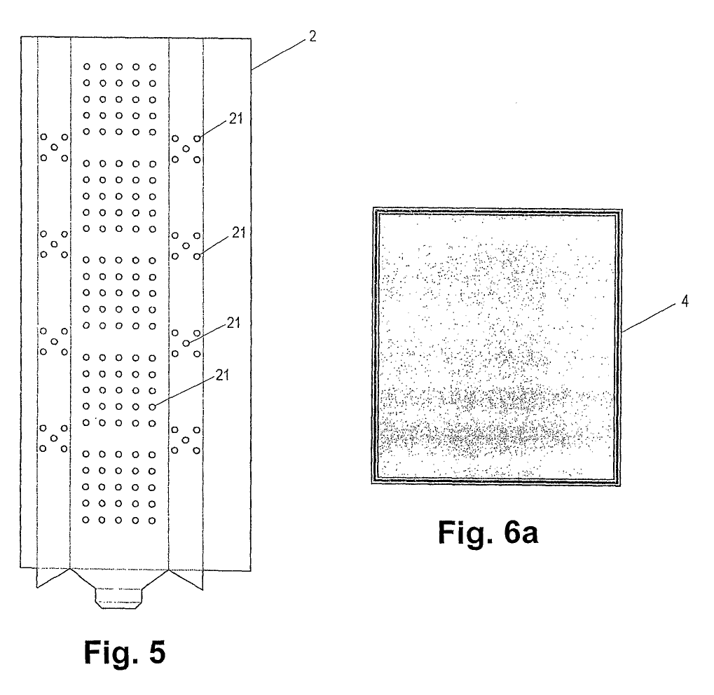

With reference to FIG. 5, the external box (2) is designed with the preparation method of UV Varnis+laminate, by adhering with Double Tape+Staples. The cardboard of the external box (2) is made of a substance of cardboard DC 310+E Flute M125/M125, with dimensions of long-side×thickness×front wide-side×back wide-side 82×3×15×7 (cm).

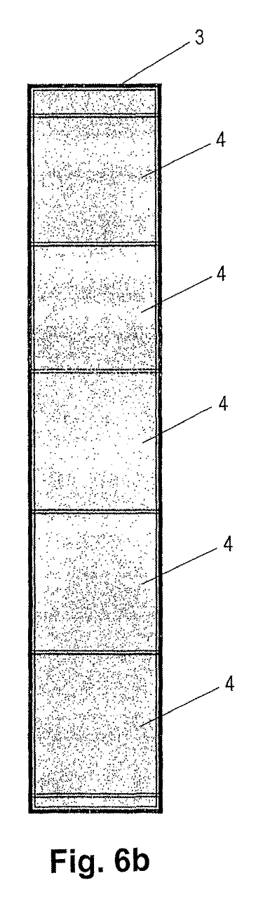

With reference to FIG. 6b, the non woven spunbound cloth is designed with the preparation method of sewed and hemmed, while the Tyvek Quted is designed with the preparation method of sealing by heating, and then filled with the active mixture of Calcium Chloride (CaCl2) and Amylopectin as much as 100 gr by using an automatic machine.

The active mixture of Calcium Chloride (CaCl2) in pellet or granular form consists of the composition: Calcium Chloride (CaCl2) 74%, Sodium Chloride (NaCl) 2.8%, Calcium Hydroxide Ca(OH)2 0.33%, Water Insoluble 0.18%, and Magnesium Chloride (MgCl2) 0.07%, with the condition pH=8.

The polymer Amylopectin, as active mixture of Calcium Chloride (CaCl2), consists of ingredients: Protein 0.09%, Fat 0.13%, Moisture 12.49%, Ash 0.16%, Starch 84.11%, Raw Fiber 0.37%, with the condition pH=6.43 (10% in water) and Electric Conductivity 187 μS.

The description of this invention has been represented for the purpose of illustration and clarification only. Of course, it will be understood that the present invention is not limited to the above description. Consequently, all variations and modifications which can be conducted by those skilled in the art of air humidity absorbing devices to be used in cargo containers, as those which have been described, will be understood as the scope of the invention, as described in the following claims.

1. An improved air humidity absorbing to be used in a cargo container, comprising:
an external box made from cardboard material;
the contents of the box including an external bags made from non woven spunbound; and
at least two internal bags from coated Tyvek material;
the at least two internal bags are formed by subdividing the external bag into the at least two internal bags, and each of the internal bags filled with an active mixture including Calcium Chloride (CaCl2) and Amylopectin.

2. The air humidity absorbing device according to claim 1, further characterized in that the external box includes holes with a hole diameter size of approximately 0.9 cm.

3. The air humidity absorbing device according to claim 1, further characterized in that the holes are located on the front surface of the box in at least five hole groups, each group consisting of approximately twenty-five holes.

4. The air humidity absorbing device according to claim 1, further characterized in that the holes are also placed on the surfaces of both box sides, each side having four hole groups, each group consisting of approximately five holes.

5. The air humidity absorbing device according to claim 1, further characterized in that the external box includes a hanger in one of its sides so it can be hung in a perpendicular position.

6. The air humidity absorbing device according to claim 1, further characterized in that the external bag made from non woven spunbound has two or more parts to place coated Tyvek.

7. The air humidity absorbing device according to claim 1, further characterized in that the external bag includes more than one bag.

8. The air humidity absorbing device according to claim 1, further characterized in that the external bag is divided into five parts.

9. The air humidity absorbing device according to claim 1, further characterized in that each of the at least two internal bags contain at least 100 gr of the active mixture.

10. The air humidity absorbing device according to claim 1, further characterized in that the active mixture includes ±50% of Calcium Cholride (CaCl2).

11. The air humidity absorbing device according to claim 1, further characterized in that the active mixture includes between 74-94.4% Calcium Chloride (CaCl2).

12. The air humidity absorbing device according to claim 1, further characterized in that the active mixture includes at least 74% Calcium Chloride (CaCl2).

13. The air humidity absorbing device according to claim 1, further characterized in that the active mixture of Calcium Chloride (CaCl2) is in the form of pellets or granules with the diameter ranging between 2-5 mm.

14. The air humidity absorbing device according to claim 1, further characterized in that the pellet or granule includes the composition: Calcium Chloride (CaCl2) 74%, Sodium Chloride (NaCl) 2.8%, Calcium Hydroxide Ca(OH)₂ 0.33%, Water Insoluble 0.18%, and Magnesium Chloride (MgCl2) 0.07%, with the condition pH=8.

15. The air humidity absorbing device according claim 1, further characterized in that the Amylopectin includes the ingredients: Protein 0.09%, Fat 0.13%, Moisture 12.49%, Ash 0.16%, Starch 84.11%, Raw Fiber 0.37%, with the condition pH=6.43 (10% in water) and Electric Conductivity 187 μS.
